(19) United States
(12) Patent Application Publication
(10) Pub. No.: US 2007/0060077 A1
(43) Pub. Date: Mar. 15, 2007

(54) Receiver architecture for wireless communication

(75) Inventor: Xuecheng Qian, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/581,808

(22) PCT Filed: Nov. 15, 2004
(86) PCT No.: PCT/IB04/52543

§ 371 Date: Jun. 2, 2006

(30) Foreign Application Priority Data
Dec. 5, 2003 (CN) 200310119785.6

(51) Int. Cl. G06F 3/033

(52) U.S. Cl. 455/130

(57) ABSTRACT

A bandpass-sampling receiver is proposed, comprising: the first Sigma-delta ADC, for converting the received RF signal into the first channel of digital signal under the control of the first sampling clock signal; the second Sigma-delta ADC, for converting the received RF signal into the second channel of digital signal under the control of the second sampling clock signal; a signal separating unit, for separating the in-phase signal and the quadrature signal in the first channel of digital signal and the second channel of digital signal. Low-resolution Sigma-delta ADC is adopted to sample and quantize the analog RF signal, thus the bandpass sampling receiver can save cost of ADCs.

### FIELD OF THE INVENTION

The present invention relates generally to a radio signal receiver for use in wireless communication systems, and more particularly, to a radio signal receiver employing bandpass sampling technique.

### BACKGROUND OF THE INVENTION

Receivers play a critical role in wireless communication fields, receiving RF signal from radio space at the antenna and converting it into baseband digital signal whose central frequency is located at zero frequency so that the desired user signal satisfying the BER (Bit Error Rate) requirement can be recovered through further baseband processing.

FIG. 1 displays a widely used conventional super heterodyne receiver. As FIG. 1 shows, antenna unit 10 sends the received analog RF signal to RF filter 20. RF filter 20 bandpass filters the analog RF signal so that the portion of the analog RF signal in the frequency band of the user signal can pass whilst the out-of-band interference far away from the frequency band of the user signal is suppressed. Then, the bandpass filtered analog RF signal is sent to LNA (low noise amplifier) 30. LNA 30 amplifies the bandpass filtered analog RF signal and outputs it to the first mixer 40. In the first mixer 40, the analog RF signal from LNA 30 is multiplied with the LO (Local Oscillator) signal with frequency of f₁ generated by LO 50, to be converted into analog IF (Intermediate Frequency) signal and outputted to IF filter 60. After receiving the analog IF signal from the first mixer 40, IF filter 60 further attenuates the out-of-band interference and outputs it to AGC (automatic gain control) 70. AGC 70 tunes the analog IF signal from IF filter 60 within a suitable dynamic range, and outputs the tuned analog IF signal to two processing paths for processing.

In the first processing path, the second mixer 80 multiplies the analog IF signal from AGC 70 by the second LO signal with frequency of f₂ generated by LO 90, to convert it into analog baseband signal, and then sends the analog baseband signal to lowpass filter 100. After receiving the analog baseband signal from the second mixer 80, lowpass filter 100 further removes the out-of-band interference out of the analog baseband signal and outputs it to AGC 120. AGC 120 performs relevant processing of the analog baseband signal from lowpass filter 100, and then sends it to ADC 140. After receiving the analog baseband signal from AGC 120, ADC (Analog-to-Digital Converter) 140 samples and quantizes the signal to get the digital baseband in-phase signal and outputs it to DSP (digital signal processing) unit 160.

In the second processing path, the second mixer 105 multiplies the analog IF signal from AGC 70 by the second LO signal with frequency of f₂ generated by LO 90 and phase shifted by 90°, to convert it into analog baseband signal, and then sends the analog baseband signal to lowpass filter 100. After receiving the analog baseband signal from the second mixer 105, lowpass filter 100 further removes the out-of-band interference out of the analog baseband signal and outputs it to AGC 130. AGC 130 performs relevant processing of the analog baseband signal from lowpass filter 110, and sends it to ADC 150. After receiving the analog baseband signal from AGC 130, ADC 150 samples and quantizes t he signal to get the digital baseband quadrature signal and outputs it to DSP unit 160.

After receiving the digital baseband in-phase signal from ADC 140 in the first processing path and the digital baseband quadrature signal from ADC 150 in the second processing path, DSP unit 160 processes them by using relevant digital signal processing techniques to recover the user signal.

The above section describes the conventional baseband sampling receiver. The conventional receiver performs most processing work on RF signals in analog domain, and thus can't adopt many state-of-the-art DSP techniques in digital domain. To overcome this deficiency, a receiver is proposed to sample analog RF signals directly, and this is the so-called bandpass sampling receiver. The sampling frequency of the bandpass sampling receiver is much less than the carrier frequency, so it is also called as sub-sampling receiver.

Due to technical restrictions, conventional RF filters can't manage to get the analog RF signal in the frequency band of the user signal whilst remove the out-of-band interference out of the frequency band of the user signal, so the filtered signal by conventional RF filters includes not only the analog RF signal in the frequency band of the user signal, but also the out-of-band interference in a very wide frequency band. In IS-95 CDMA system for example, the bandwidth of a channel (or namely the frequency bandwidth of the user signal) is 1.25 MHz, but the bandwidth of the analog signal filtered out by the RF filter is usually more than 100 MHz. In the 100 MHz analog RF signal, besides the 1.25 MHz user signal, others are all out-of-band interference. To avoid the out-of-band interference folding into the frequency band of the user signal during sampling, the sampling frequency of the ADC used in conventional bandpass sampling receiver must be more than or equal to twice the width of the analog RF signal outputted by the RF filter, according to the sampling principle of bandpass signal.

Moreover, the dynamic range of the analog RF signal outputted from the RF filter is very broad, so the ADC used in conventional bandpass sampling receivers should have very high resolution, to decrease the interference of quantization noise to the user signal.

As described above, the ADC must have relatively high sampling frequency and resolution to implement conventional bandpass sampling, but this will usually lead to very high cost and power consumption.

### SUMMARY OF THE INVENTION

An object of the present invention is to provide a bandpass sampling receiver for use in mobile communication systems. In this bandpass sampling receiver, two processing paths respectively use ADCs to sample and quantize the RF analog signal outputted from the RF filter, thus the corresponding ADCs can sample the analog RF signal by using the sampling frequency less than twice but more than the bandwidth of the RF analog signal.

Another object of the present invention is to provide a bandpass sampling receiver for use in mobile communication systems. In this bandpass sampling receiver, Sigma-delta ADCs are used to sample and quantify the RF analog signal outputted from the RF filter, thus the quantization noise is pushed into higher frequency band and thus the user signal avoids being interfered.

A bandpass-sampling receiver is proposed for receiving RF signals, comprising: the first Sigma-delta ADC, for converting the received RF signal into the first channel of digital signal under the control of the first sampling clock signal; the second Sigma-delta ADC, for converting the received RF signal into the second channel of digital signal under the control of the second sampling clock signal; a signal separating unit, for separating the in-phase signal and the quadrature signal in the first channel of digital signal and the second channel of digital signal.

### BRIEF DESCRIPTION OF THE DRAWINGS

For a detailed description of the preferred embodiments of the invention, reference will now be made to the accompanying drawings in which:

FIG. 1 is a schematic diagram illustrating a widely used conventional super heterodyne receiver;

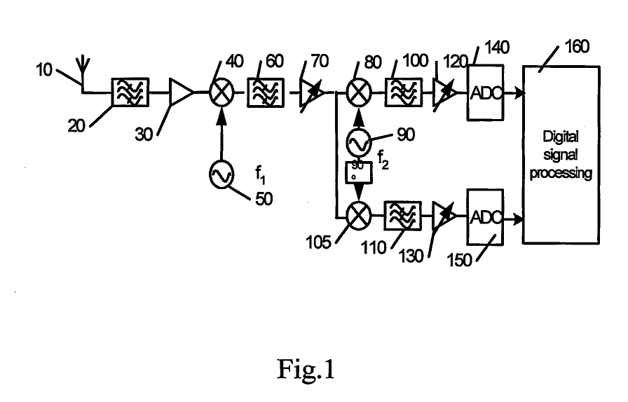

FIG. 2 is a schematic diagram illustrating the bandpass sampling receiver for use in wireless communication systems in accordance with an embodiment of the present invention;

FIG. 3 illustrates the structure of the Sigma-delta ADC in an embodiment of the present invention.

### DETAILED DESCRIPTION OF THE INVENTION

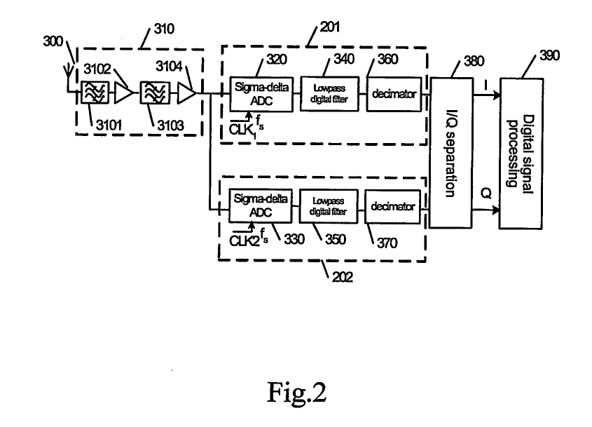

FIG. 2 illustrates the bandpass sampling receiver for use in wireless communication systems in accordance with an embodiment of the present invention. The bandpass sampling receiver will be described in detail below, in conjunction with FIG. 2.

As FIG. 2 shows, antenna unit 300 receives analog RF signal containing the user signal from the radio medium, and sends the received analog RF signal to RF filtering and amplifying unit 310.

After receiving the analog RF signal from antenna unit 300, RF filtering and amplifying unit 310 first uses RF filter 3101 to bandpass filter the received analog RF signal, to attenuate the out-of-band interference out of the frequency band of the user signal, and then uses LNA 3102 to low-noise amplify the analog RF signal from RF filter 3101 and output it. To achieve better band sensitivity and higher processing gain, RF filtering and amplifying unit 310 can also connect an RF filter 3103 and LNA 3104 behind LNA 3102 in cascade. Wherein RF filter 3103 bandpass filters the analog RF signal outputted from LNA 3102 to further attenuate the out-of-band interferences out of the frequency band of the user signal, while LNA 3104 low-noise amplifies the analog RF signal from RF filter 3103 and output it.

The analog RF signal outputted from RF filtering and amplifying unit 310 is divided into two channels, and will be processed by processing modules 201 and 202. We will describe the processing procedure of analog RF signal in the two processing modules.

1. AD (Analog-to-Digital) Conversion

In processing modules 201 and 202, after respectively receiving the analog RF signal outputted from RF filtering and amplifying unit 310, Sigma-delta ADCs 320 and 330 of the same architecture use the same sampling frequency less than the carrier frequency of the analog RF signal and more than the bandwidth of the analog RF signal, to sample and quantize the analog RF signal, to convert the analog RF sign al into digital signals and output them respectively.

If said sampling frequency is more than the bandwidth of said analog RF signal, the out-of-band interference included in said analog RF signal will not fold into the frequency band of the user signal. Compared with conventional bandpass sampling receivers that require a sampling frequency more than twice the bandwidth of said analog RF signal, the sampling frequency in the present invention is decreased considerably. Although the sampling frequency to be used in the present invention is much lower than that required in conventional bandpass sampling receivers, it's still much higher than the bandwidth of the user signal. Due to the inherent over-sampling characteristic of Sigma-delta ADCs 320 and 330 (compared with the bandwidth of the user signal), Sigma-delta ADCs 320 and 330 can support such sampling frequency well.

In addition to the above conditions, the sampling frequencies CLK₁ and CLK₂ used by Sigma-delta ADCs 320 and 330 must be 1/N (N is an integer) of the carrier frequency of said analog RF signal, so that frequency component of the user signal can exist at zero frequency when the user signal included in said analog RF signal is continued in frequency domain with the sampling frequency as the cycle. The baseband I&Q components of the user signal can be computed according to the frequency component of the user signal at zero frequency, with the method as described in the patent application document entitled “bandpass sampling receiver and the sampling method”, submitted along with the present application, by KONINKLIJKE PHILIPS ELECTRONICS N.V., Attorney's Docket No. CN030070, and incorporated by reference herein.

According to the bandpass sampling method as disclosed in the application, in order to compute the baseband I&Q components of the user signal by taking advantage of the known signal (such as pilot signal or midamble signal), there must be a fixed relative delay T between the sampling clocks of Sigma-delta ADCs 320 and 330. The relative delay T must be far less than the reciprocal of the bandwidth of the baseband signal, that is T<< 1/B, and ω_{c}τ≠nπ, wherein ω_{c} is the circular frequency of the carrier signal and n is a natural number. In this way, the baseband in-phase component and quadrature component of the user signal can be obtained.

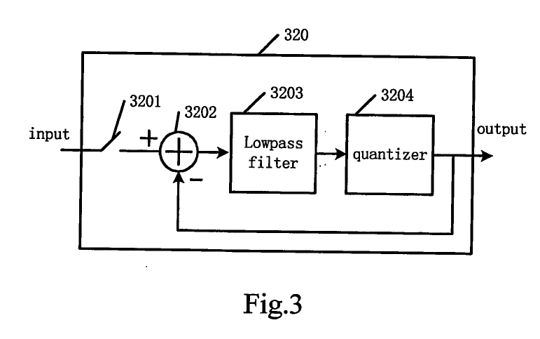

In the present invention, utilization of Sigma-delta ADCs 320 and 330 can use sampling frequencies less than the requirement of conventional bandpass sampling receivers, as well as lower the resolution requirement of ADCs (for example, 1-bit resolution can be adopted). Although this will produce some quantization noise, the quantization noise won't result in distortion of the user signal. As to the why quantization noise won't cause distortion of the user signal when using Sigma-delta ADCs, a description will be given below in conjunction with FIG. 3.

2. Digital Filtering

The digital signals outputted from Sigma-delta ADCs 320 and 330, are respectively lowpass filtered at lowpass filters 340 and 350 in their corresponding processing paths, so that said out-of-band interference and the quantization noise pushed to higher frequency band can be removed and only the baseband digital signal included in the user signal at zero frequency is gotten.

3. Decimation

The baseband digital signal of the user signal outputted by lowpass digital filters 340 and 350, is respectively decimated at decimators 360 and 370 in their processing paths, to further decrease the data rate of the baseband digital signal of the user signal.

The processing procedure of the analog RF signal in processing modules 201 and 202 is elaborated as above.

Processing modules 201 and 202 send their processed baseband digital signals to I/Q separating unit 380. After receiving the baseband digital signals from processing modules 201 and 202, I/Q separating unit 380 computes the baseband in-phase and quadrature components of the user signal, by using the bandpass sampling method as disclosed in the above application. More specifically: first, the initial phase computing unit in I/Q separating unit 380 computes the initial phases of the RF signal relative to the two channels of sampling clock signals CLK₁ and CLK₂; then, I/Q signal separating unit in I/Q separating unit 380 separates the in-phase signal in said first channel of baseband digital signal and said second channel of baseband digital signal from the quadrature signal therein, and outputs the in-phase signal component and quadrature signal component to DSP unit 390.

After receiving the in-phase signal component and the quadrature signal component of the user signal from I/Q separating unit 380, DSP unit 390 performs relevant processing (for example, demodulation, channel decoding, source decoding and so on) on the received in-phase signal component and the quadrature signal component by using conventional DSP methods, to get the desired user signal.

The following section will elaborate the principle why quantization noise won't cause distortion of the user signal when using Sigma-delta ADCs, in conjunction with the schematic structure of Sigma-delta ADC 320 as shown in FIG. 3.

Referring to Sigma-delta ADC 320 as shown in FIG. 3, first, analog RF signals are converted into discrete sampling signals at sampler 3201 and outputted to the in-phase input end (+) of comparator 3202 in turn. Then, every time the in-phase input end (+) receives a sampling signal from sampler 3201, it will compare the sampling signal with the feedback signal from the output end of the ADC received at the out-phase input end (−), and output the comparison result to lowpass filter 3203. Afterwards, lowpass filter 3203 filters the received comparison result from comparator 3202, and outputs it to quantizer 3204. Finally, quantizer 3204 quantizes the received comparison result from lowpass filter 3203 into digital signal and outputs it, meanwhile the digital signal is returned to the out-phase input end (−) of comparator 3202 in form of feedback signal.

FIG. 3 indicates that quantization noise is produced during quantization process, so the digital signal obtained from the quantization of quantizer 3204 contains quantization noise, and accordingly, the comparison result outputted by comparator 3202 also contains quantization noise. The lower is the resolution of quantinzer 3204 (i.e. the lower is the resolution of the ADC), the more quantization noise is contained in said digital signal and comparison result. But thanks to lowpass filter 3203 and the system feedback link, most quantization noise produced by the quantizer in the ADC is pushed to higher frequency band, and won't enter into the frequency band of the user signal to cause distortion of the user signal. Furthermore, the sampling frequency to be used by sampler 3201 is much higher than the bandwidth of the user signal, so the frequency of the quantization noise produced during quantization is still very high. The quantization noise can be pushed to very high frequency band by using lowpass filter 3203 of relatively low order, and the cost of the corresponding ADC can be very low.

Beneficial Results of the Invention

As stated above, the proposed bandpass sampling receiver utilizes sampling technique of two processing paths, thus the corresponding ADCs can sample the analog RF signal by using the sampling frequency less than twice but more than the bandwidth of the RF analog signal, compared with conventional bandpass sampling receivers. So, the power consumption and cost of the ADC can be saved.

Moreover, the proposed bandpass sampling receiver can use low-resolution Sigma-delta ADCs to sample and quantize the analog RF signal, so the cost of the Sigma-delta ADC can be further saved.

It is to be understood by those skilled in the art that the bandpass sampling receiver for use in wireless communication systems as disclosed in this invention can be modified considerably without departing from the spirit and scope of the invention as defined by the appended claims.

What is claimed is:

1. A bandpass sampling receiver for receiving RF signals, comprising:
a first Sigma-delta ADC, for converting the received RF signal into the first channel of digital signal under the control of the first sampling clock signal;
a second Sigma-delta ADC, for converting the received RF signal into the second channel of digital signal under the control of the second sampling clock signal;
a signal separating unit, for separating the in-phase signal and the quadrature signal in the first channel of digital signal and the second channel of digital signal.

2. The receiver of claim 1, wherein the frequency of the first sampling clock signal and the second sampling clock signal is 1/N of that of the RF signal, where N is a natural number.

3. The receiver of claim 2, wherein there exists a relative delay τ between the first sampling clock signal and the second sampling clock signal, and the relative delay τ meets the condition that ω_{c}τ≠nπ, where ω_{c}is the circular frequency of the RF signal and n is a natural number.

4. The receiver of claim 3, further comprising:
a first lowpass filter, for receiving the first channel of digital signal and outputting the first channel of digitally filtered baseband digital signal to the signal separating unit;
a second lowpass filter, for receiving the second channel of digital signal and outputting the second channel of digitally filtered baseband digital signal to the signal separating unit.

5. The receiver of claim 4, wherein the signal separating unit includes:
an initial phase computing unit, for computing the initial phases of the RF signal relative to the first sampling clock signal and the second sampling clock signal, according to the known signal previously obtained;
an I&Q signal separating unit, for separating the in-phase signal and the quadrature signal in the first channel of digital signal and the second channel of digital signal, according to the initial phases.

6. The receiver of claim 5, wherein the known signal can be the pilot signal or the midamble signal.

7. The receiver of claim 4, further comprising:
the first decimator, for receiving the first channel of baseband digital signal and outputting the first channel of baseband digital signal after decimation to the signal separating unit;
the second decimator, for receiving the second channel of baseband digital signal and outputting the second channel of baseband digital signals after decimation to the signal separating unit.

8. The receiver of claim 4, further comprising an RF receiving unit, the RF receiving unit including:
a plurality of RF filters, the plurality of RF filters cascade connected with each other, for filtering the received RF signal in turn;
a LNA (low noise amplifier), for amplifying the filtered signal, and supplying the amplified filtered RF signal to the first Sigma-delta ADC and second Sigma-delta ADC.

9. A method to be performed in bandpass sampling receivers, comprising:
(a) converting the received RF signal into the first channel of digital signal in Sigma-delta AD conversion mode, under the control of the first sampling clock signal;
(b) converting the received RF signal into the second channel of digital signal in Sigma-delta AD conversion mode, under the control of the second sampling clock signal;
(c) separating the in-phase signal and the quadrature signal in the first channel of digital signal and the second channel of digital signal.

10. The method of claim 9, wherein the frequency of the first sampling clock signal and the second sampling clock signal is 1/N of that of the RF signal, where N is a natural number.

11. The method of claim 10, wherein there exists a relative delay τ between the first sampling clock signal and the second sampling clock signal and the relative delay τ meets the condition that ω_{c}τ≠nπ, where ω_{c}, is the circular frequency of the RF signal and n is a natural number.

12. The method of claim 11, further comprising:
filtering the first channel of digital signal and outputting the first channel of filtered baseband digital signal;
filtering the second channel of digital signal and outputting the second channel of filtered baseband digital signal;
wherein the in-phase signal and the quadrature signal in the first channel of digital signal and the second channel of digital signal are separated in step (c).

13. The method of claim 12, wherein the step (c) includes:
computing the initial phases of the RF signal relative to the first sampling clock signal and the second sampling clock signal, according to the known signal previously obtained;
separating the in-phase signal and the quadrature signal in the first channel of digital signal and the second channel of digital signal, according to the initial phases.

14. The method of claim 13, wherein the known signal can be the pilot signal or the midamble signal.

15. A UE (user equipment), comprising:
a transmitter, for transmitting RF signals;
a receiver, for receiving RF signals, the receiver including:
the first Sigma-delta ADC, for converting the received RF signal into the first channel of digital signal under the control of the first sampling clock signal;
the second Sigma-delta ADC, for converting the received RF signal into the second channel of digital signal under the control of the second sampling clock signal;
a signal separating unit, for separating the in-phase signal and the quadrature signal in the first channel of digital signal and the second channel of digital signal.

16. The UE of claim 15, wherein the frequency of the first sampling clock signal and the second sampling clock signal is 1/N of that of the RF signal, where N is a natural number.

17. The UE of claim 16, wherein there exists a relative delay τ between the first sampling clock signal and the second sampling clock signal and the relative delay τ meets the condition that ω_{c}τ≠nπ, where ω_{c} is the circular frequency of the RF signals and n is a natural number.

18. The UE of claim 17, further comprising:
a first lowpass filter, for receiving the first channel of digital signal and outputting the first channel of digitally filtered baseband digital signal to the signal separating unit;
a second lowpass filter, for receiving the second channel of digital signal and outputting the second channel of digitally filtered baseband digital signal to the signal separating unit.

19. The UE of claim 18, wherein the signal separating unit further includes:
an initial phase computing unit, for computing the initial phases of the RF signal relative to the first sampling clock signal and the second sampling clock signal, according to the known signal previously obtained;
an I&Q signal separating unit, for separating the in-phase signal and the quadrature signal in the first channel of digital signal and the second channel of digital signal, according to the initial phases.

20. The UE of claim 19, wherein the known signal can be the pilot signal or the midamble signal.

21. The UE of claim 18, further comprising:
the first decimator, for receiving the first channel of baseband digital signal and outputting the firs t channel of baseband digital signal after decimation to the signal separating unit; the second decimator, for receiving the second channel of baseband digital signal and outputting the second channel of baseband digital signal after decimation to the sign al separating unit.

22. The UE of claim 18, further comprising an RF receiving unit, the RF receiving unit including:
a plurality of RF filters, the plurality of RF filters cascade connected with each other, for filtering the received RF signal in turn;
a LNA, for amplifying the filtered signal, and supplying the amplified filtered RF signal to the first Sigma-delta ADC and second Sigma-delta ADC.
